(19) United States
(12) Patent Application Publication
(10) Pub. No.: US 2005/0194175 A1
(43) Pub. Date: Sep. 8, 2005

(54) Grommet

(75) Inventors: Yasuyoshi Serizawa, Utsunomiya-shi (JP); Hiroyuki Sasaki, Utsunomiya-shi (JP)

Correspondence Address: SUGHRUE MION, PLLC, 2100 PENNSYLVANIA AVENUE, N.W., SUITE 800, WASHINGTON, DC, 20037, US

(73) Assignee: YAZAKI CORPORATION

(21) Appl. No.: 11/070,289

(22) Filed: Mar. 3, 2005

(30) Foreign Application Priority Data
Mar. 3, 2004 (JP) P2004-058891

(51) Int. Cl. H02G 3/18

(52) U.S. Cl. 174/65 G

(57) ABSTRACT

A grommet includes a grommet body made of rubber, and an inner grommet made of a synthetic resin. The grommet body includes a tube, and a flat portion. An abutment portion is provided at the flat portion. The inner grommet includes a bottom wall, and a peripheral wall. The peripheral wall is formed on and is projected perpendicularly from an outer edge of the bottom wall. The edge of the peripheral wall faces to the abutment portion. A projecting portion is formed at the edge. The grommet body and the inner grommet are fixed to each other, with the projecting portion held in biting engagement with the abutment portion. A wire harness is passed through a space between the grommet body and the inner grommet.

### BACKGROUND OF THE INVENTION

This invention relates to a grommet that is mounted on a panel forming a car body of an automobile (vehicle), and passes a wire harness therethrough.

For installing a wire harness on a door and a car body of an automobile (vehicle), a so-called throughless grommet 101: (see, for example, Patent Literature 1) shown in FIGS. 8 and 9 is used to prevent liquid, such as water from the exterior the automobile, from depositing on the wire harness. The throughless grommet (hereinafter referred to merely as “grommet”) 101 shown in FIGS. 8 and 9, comprises a grommet body 102 made of an elastic material (such as rubber), and an: inner grommet 103 made of a synthetic resin.

The grommet body 102 includes a tube (tubular portion) 104, and a flat portion (plate-like portion) 105 to which one end of the tube 104 is connected. A wire harness 106 is passed through the tube 104. The tube 104 extends through the flat portion 105. The flat portion 105 positions the wire harness 106, passing through the tube 104, on the surface thereof. A plate member 107 made of a synthetic resin is embedded in the flat portion 105. The plate member 107 has retaining piece portions 108 projecting from the flat portion 105. The flat portion 105 further includes a lip 110 for abutting against a door panel (i.e., a panel forming a car body of the automobile) 109 to form a watertight seal therebetween.

The inner grommet 103 is made of a synthetic resin, and includes a panel mounting portion 111, and a harness escape portion 112. The panel mounting portion 111 has a bottom wall 113 and a plurality of peripheral walls (side walls) 114 extending perpendicularly from an outer peripheral edge of the bottom wall 113. A retaining portion 116 for retaining engagement in a hole 115 in the door panel 109 is formed on and projects perpendicularly from the bottom wall. Retaining projections 117 are formed on the peripheral walls 114, and are retainingly engaged with the retaining piece portions 108, respectively.

The harness escape portion 112 has a tubular shape, and is formed on and projects perpendicularly from the bottom wall 113. The harness mounting portion 112 is communicated with a space formed by the bottom wall 113 and the plurality of peripheral walls 114, that is, the interior of the harness mounting portion 111. The retaining projections 117 are retainingly engaged with the retaining piece portions 108, respectively, thereby fixing the inner grommet 101 and the grommet body 102 to each other, thus assembling the grommet 101. In the grommet 101, the wire harness 106 is passed sequentially through the tube 104, the space between the flat portion 105 of the grommet body 102 and the panel mounting portion of the inner grommet 103, and the harness escape portion 112.

The grommet 101 is mounted on the door panel 109, with the retaining portion 116 of the panel mounting portion 111 retainingly engaged in the hole 115. The lip 110 is held against the door panel 109 to form a watertight seal therebetween, thereby preventing water from intruding between the grommet 101 and the door panel 109. The wire harness 106, passing through the grommet 101, is connected to car body-side electronic equipments and door-side electronic equipments. Thus, the grommet 101 enables the wire harness 106 to be installed on the car body and the door, and also prevents liquid such as external water from depositing on the installed wire harness 106.

[Patent Literature 1] JP-A-2000-168466

In the above related grommet 101, the retaining piece portions 108 made of a synthetic resin project from the flat portion 105, and the retaining projections 117 on the inner grommet 103 made of a synthetic resin are retainingly engaged with these retaining piece portions 108, respectively. Thus, the synthetic resin-made retaining piece portions 108 are directly superposed on the peripheral walls 114 of the inner grommet 103. Therefore, there has been a fear that liquid (such as water), intruding between the lip 110 and the door panel 109, moves to the surfaces of the retaining piece portions 108 and peripheral walls 114 because of the capillary action, and intrudes between the grommet body 102 and the inner grommet 103 (that is, intrudes into the grommet 101) therethrough. Therefore, there has been a fear that liquid such as external water deposits on the wire harness 106 received in the related grommet 101.

### SUMMARY OF THE INVENTION

It is therefore an object of this invention to provide a grommet capable of positively preventing liquid such as water from depositing on a wire harness received in the grommet.

(1) A grommet comprising:

a grommet body that is made of an elastic material and includes a flat portion which has a through hole and a tube portion which is communicated with the through hole; and
an inner grommet that is made of a synthesis resin and includes a bottom wall and a periphery wall which is extended from an outer edge of the bottom wall in a direction facing to the grommet body,
wherein the flat portion, the bottom wall and the periphery wall define a portion through which a wire is adapted to be passed,
wherein a first projecting portion is formed at one of an edge of the periphery wall which is opposed to the bottom portion and an abutment portion which is disposed at the flat portion and faces to the edge of the periphery wall, and
wherein when the inner grommet is fixed to the grommet body, the first projecting portion is held in contact with the other of the edge of the periphery wall and the abutment portion.
   (2) The grommet according to (1), wherein an entire length of the edge of the periphery wall faces to the abutment portion.
   (3) The grommet according to (1), wherein the first projecting portion is formed at the edge of the periphery wall.
   (4) The grommet according to (1), wherein the first projecting portion is formed at the abutment portion.
   (5) The grommet according to (1),
wherein a plurality of receiving portions are provided at the flat portion,
wherein a plurality of retaining portions are provided at outsides of the periphery wall and are corresponding to the receiving portions, and
wherein the retaining portions are engaged to the receiving portions, so that the inner grommet is fixed to the grommet body.
   (6) The grommet according to (1),
wherein a plurality of retaining portions are formed at a surface of the bottom wall opposed to the periphery wall, and
wherein the retaining portions are retained to a panel member that is a part of automobile parts.
   (7) The grommet according to (6),
wherein second projecting portions are formed at portions of an edge of the grommet body, and
wherein the second projecting portions are held in contact with portions of the panel member when the retaining portions are retained to the panel member.

According to the invention, when the grommet body and the inner grommet are fixed to each other, the grommet body made of the elastic material is held in direct contact with the inner grommet made of the synthetic resin. Therefore, a watertight seal is positively formed between the grommet body and the inner grommet by the projecting portion and the other of the abutment portion and the edge of the peripheral wall. Therefore, liquid such as water is prevented from depositing on the wire harness received in the grommet.

According to the invention, the projecting portion is held in contact with the other of the abutment portion and the edge of the peripheral wall over the entire length of the peripheral wall, so that the grommet body made of the elastic material is held in direct contact with the inner grommet made of the synthetic resin. A watertight seal is formed between the grommet body and the inner grommet over the entire length of the peripheral wall, thereby positively preventing liquid such as water from depositing on the wire harness received in the grommet.

According to the invention, when the grommet body and the inner grommet are fixed to each other, the projecting portion bites into the abutment portion, so that the grommet body made of the elastic material is held in direct contact with the inner grommet made of the synthetic resin. Therefore, a watertight seal is more positively formed between the grommet body and the inner grommet, thereby more positively preventing liquid such as water from depositing on the wire harness received in the grommet.

According to the invention, the inner grommet and hence the grommet can be positively fixed to the panel, and liquid such as water is prevented from intruding between the grommet body and the panel. Therefore, liquid such as water is still more positively prevented from depositing on the wire harness received in the grommet.

### BRIEF DESCRIPTION OF THE DRAWING

FIG. 1 is a perspective view of a door on which one preferred embodiment of a grommet of the present invention is mounted.

FIG. 2 is an exploded, perspective view of the grommet of FIG. 1.

FIG. 3 is a cross-sectional view of the grommet of FIG. 2, showing important portions thereof.

FIG. 4 is an exploded cross-sectional view of the grommet of FIG. 3.

FIG. 5 is a plan view of an inner grommet of the grommet of FIG. 2.

FIGS. 6A to 6C are views explanatory of a process of fixing a grommet body and the inner grommet of the grommet of FIG. 4 to each other.

FIGS. 7A to 7C are views explanatory of a process of fixing a grommet body and an inner grommet of a modified form of the grommet of FIG. 4 to each other.

FIG. 8 is a perspective view of a related grommet.

FIG. 9 is a cross-sectional view of the grommet of FIG. 8, showing important portions thereof.

### DETAIL DESCRIPTION OF PREFERRED EMBODIMENT

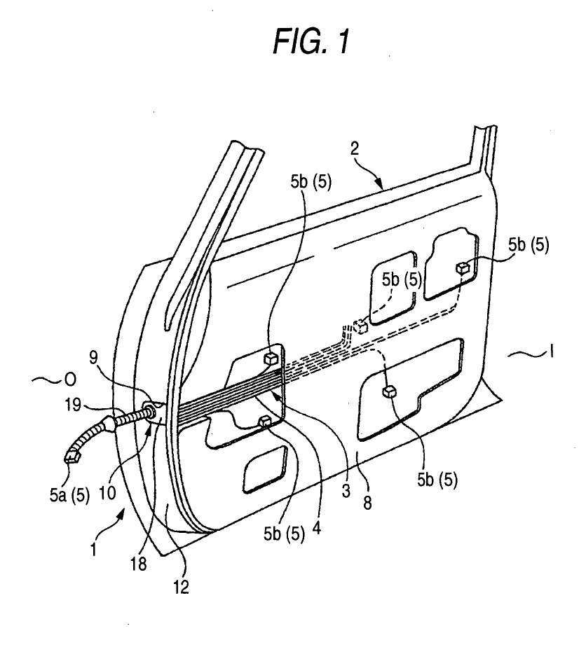

One preferred embodiment of a grommet of the present invention will now be described with reference to FIGS. 1 to 6. One preferred embodiment of the grommet 1 (shown in FIG. 1 and other Figures) of the invention is a so-called throughless grommet, and is used to install a wire harness 3 (shown in FIG. 1) on a car body of an automobile (vehicle) and a door 2 (shown in FIG. 1) pivotally mounted on the car body.

As shown in FIG. 1, the wire harness 3 comprises a plurality of wires 4, and a plurality of connectors 5. The wire 4 is a so-called sheathed wire including an electrically-conductive core wire (conductor), and an insulative sheath. The conductor is formed of twisted wire elements made of metal such as copper. The sheath is made of an insulative synthetic resin, and covers the conductor.

The connectors 5 are mounted on end portions of the wires 4. One (designated by reference numeral 5a) of the plurality of connectors 5 is adapted to be fitted to a connector (not shown) of a car body-side wire harness. The other connectors 5 (designated by reference numeral 5b) are fitted respectively to connectors of various electronic equipments (such as a speaker, a switch unit, a door lock unit and a power window motor) mounted on the door 2.

The wire harness 3 of the above construction supplies various signals and electric power from the car body to the electronic equipments mounted on the door 2 via the connectors 5a and 5b fitted to the respective mating connectors. The wire harness 3 also supplies signals from the switch unit to the car body-side wire harness via the connectors 5a and 5b fitted to the respective mating connectors.

As shown in FIG. 1, the door 2 is formed of a metal sheet, and includes a door panel 8 pivotally mounted on the car body by hinges (not shown), and a door trim (not shown) mounted on an inner side of the door panel 8. The various electronic equipments (such as the speaker, the switch unit, the door lock unit and the power window motor) are mounted on the door panel 8 of the door 2. The door panel 8 is a panel forming the car body of the automobile recited in the present specification.

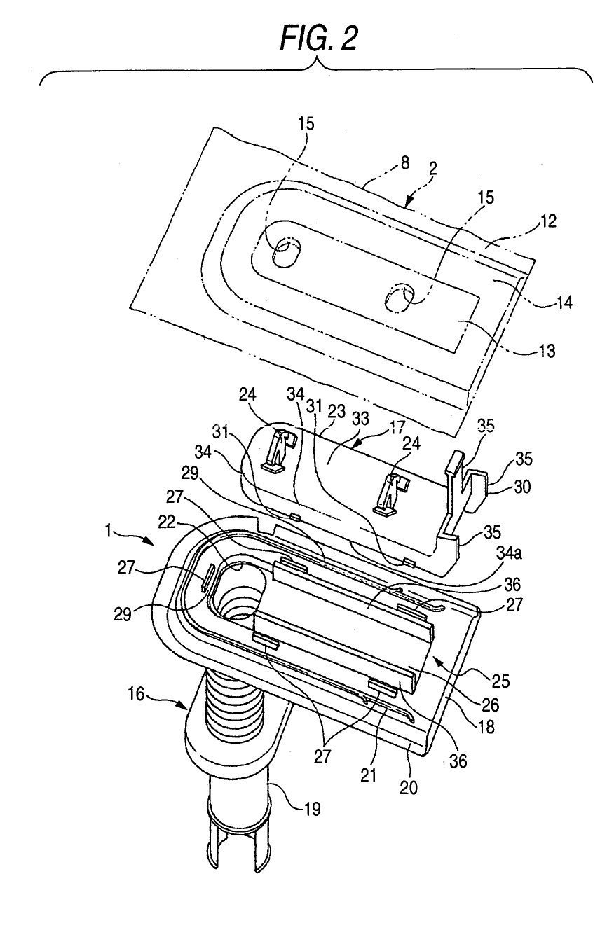

As shown in FIGS. 1 and 2, a recess 9 is formed in that end surface 12 of the door panel 8 facing to the hinges. The recess 9 is, of course, recessed from the end surface 12. The recess 9 extends linearly from an inside (car inside I) edge of the end surface 12 of the door panel 8 toward the outside O of the car. A car inside (I) end of the recess 9 is disposed at a level higher than a car outside (O) end of the recess 9. Namely, the recess 9 is slanting downwardly relative to a horizontal direction gradually from the inner side (car inside I) of the door 2 toward the outer side (car outside O).

As shown in FIG. 2, the recess 9 includes a deep groove portion 13 for receiving an inner grommet 17 (described later) of the grommet 1, and a shallow groovy portion 14 provided around the periphery of the deep groove portion 13. The depth of the deep groove portion 13 from the end surface 12 is larger than the depth of the shallow groove portion 14 from the end surface 12. The grommet 1 is adapted to be mounted in the recess 9.

As shown in FIG. 2, a plurality of holes 15 is formed through a bottom of the deep groove portion 13. In the illustrated embodiment, two holes 15 are provided. The two holes 15 are spaced from each other in the longitudinal direction of the recess 9, that is, in the direction from the outer side (car outside O) of the door 2 toward the inner side (car inside I).

As shown in FIGS. 2 to 4, the grommet 1 includes a grommet body 16 made of an elastic material such as rubber, and the inner grommet 17 made of a synthetic resin.

The grommet body 16 includes a flat portion 18, a tube (tubular portion) 19, and a plurality of second projecting potions 20 and 21, the grommet body 16 being formed into an integral construction. The flat portion 18 has a plate-like shape. The flat portion 18 is generally equal in plane shape (i.e., shape as viewed from the top) to the recess 9. As shown in FIG. 2, a hole 22 is formed through the flat portion 18.

A flat plate-like plate member 25 made of a synthetic resin is embedded in the flat portion 18. The plate member 25 includes a flat plate-like body portion 26, a plurality of receiving portions 27, and guide plate portions 36. The body portion 26 is equal in plane shape to the flat portion 18, and is smaller in plane shape than the flat portion 18 in size. The hole 22 extends through the body portion 26.

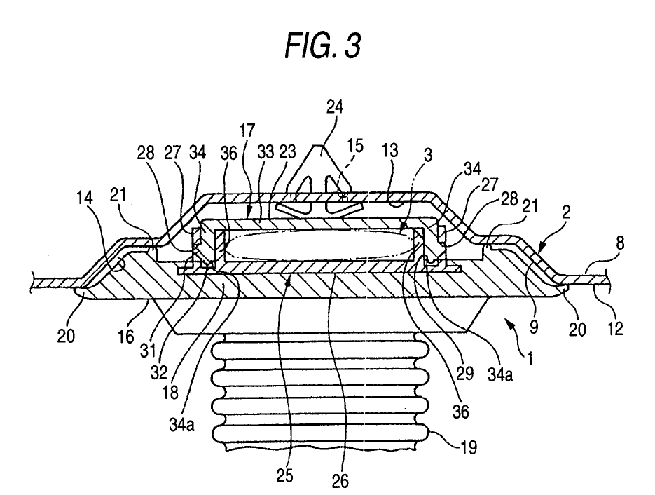

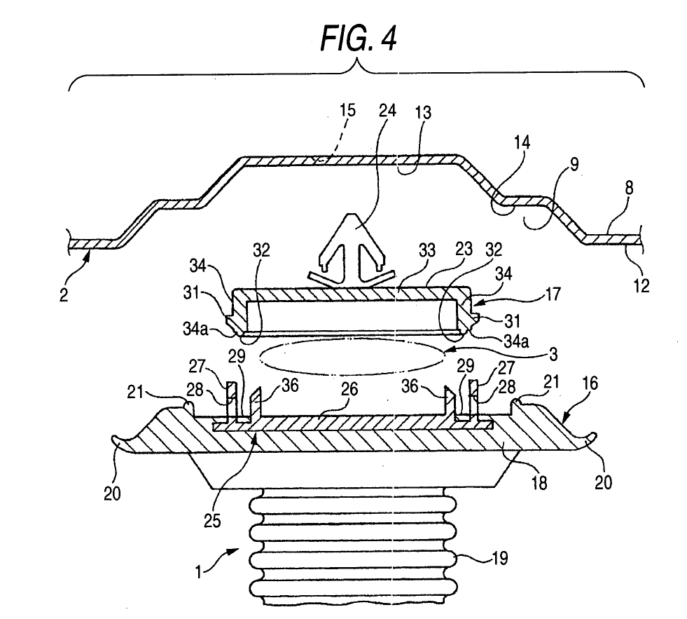

There are provided the plurality of receiving portions 27. Each receiving portion 27 has a piece-like shape, and is formed in an upstanding manner on the body portion 26, and projects outwardly beyond the flat portion 18 through an abutment portion 29 (described later). The receiving portion 27 has a hole 28 (shown in FIGS. 3 and 4) in which a retaining portion 31 (described later) of the inner grommet 17 is retainingly engaged. The retaining portion 31 is retainingly engaged in the hole 28, and therefore is locked to the receiving portion 27.

There are provided the pair of guide plate portions 36, and each guide plate portion 36 is disposed at a portion inwardly of the receiving portions 27 and the abutment portion 29, and is formed in an upstanding manner on the body portion 26. When the grommet body 16 and the inner grommet 17 are fixed to each other, the guide plate portions 36 are disposed at a portion inwardly of peripheral wall (side walls) 34 in superposed relation thereto. When the grommet body 16 and the inner grommet 17 are to be fixed to each other, the guide plate portions 36 guide the peripheral wall 34 so that the retaining portions 31 can be brought into retaining engagement with the receiving portions 27, respectively. The pair of guide plate portions 36 also serve to position the wire harness 3 therebetween, thereby preventing the wire harness from being clamped between the grommet body 16 and the inner grommet 17.

The abutment portion 29 is provided at the flat portion 18. The abutment portion 29 is made of the elastic material (such as rubber) forming the grommet body 16. The abutment portion 29 covers an outer peripheral edge portion of the plate member 25 (in such a manner that this outer peripheral edge portion lies immediately beneath the abutment portion 29). When the grommet body 16 and the inner grommet 17 are fixed to each other with the retaining portions 31 retainingly engaged with the respective receiving portions 27, the abutment portion 29 faces to an edge 34a of the peripheral wall 34 (described later) of the inner grommet 17 opposed to a bottom wall 33 of the inner grommet 17. The abutment portion 29 faces to the edge 34a of the peripheral wall 34 over the entire length of the peripheral wall 43.

The flat portion 18 positions the wire harness 3 on its surface having the abutment surface 29 formed thereon. The plate member 25, having the receiving portions 27, is embedded in the flat portion 18, and the abutment portion 29 is provided at the flat portion 18, and therefore the grommet body 16 is provided with the receiving portions 27 and the abutment portion 29.

The tube 19 is formed into a tubular (cornice-like) shape, and is continuous at one end with that portion of the flat portion 18 defining a peripheral edge portion of the hole 22. Therefore, the tube 19 communicates with the hole 22. The tube 19 extends from that portion of the flat portion 18, defining the peripheral edge portion of the hole 22, in a direction away from the receiving portions 27. The wire harness 3 is passed through the tube 19 and the hole 22.

The second projecting portion 20 (which is one of the two second projecting portions 20 and 21) is formed on an outer peripheral edge of the flat portion 18. When the grommet 1 is mounted in the recess 9, the second projecting portion 20 is held in contact with that portion of the end surface 12 around the recess 9 to form a watertight seal therebetween. As shown in FIG. 2, the other second projecting portion 21 on the flat portion 18 is disposed at a portion inwardly of the second projecting portion 20. The second projecting portion 21 surrounds the inner grommet 17 mounted on the grommet body 16. When the grommet 1 is mounted in the recess 9, the second projecting portion 21, projecting from the flat portion 18 toward the end surface 12, abuts against an inner peripheral edge portion of the shallow groove portion 14 to form a watertight seal therebetween. Each of the second projecting portions 20 and 21 abuts against the door panel 8 to form a watertight seal therebetween.

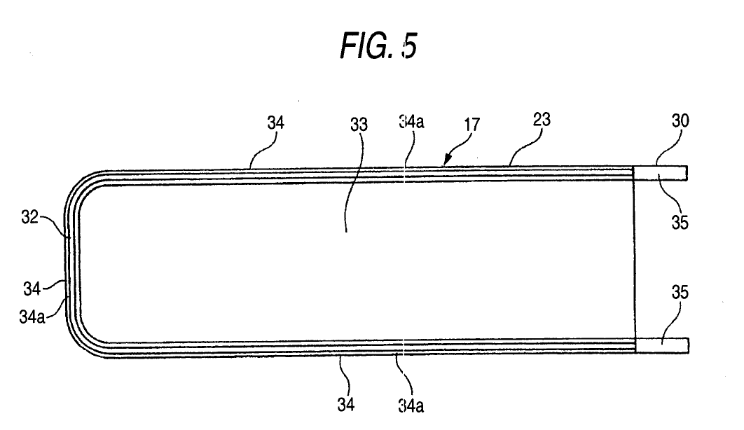

As shown in FIGS. 3 and 4, the inner grommet 17 includes a body portion 23 (shown in FIG. 5), a harness guide portion 30 (shown in FIG. 5), the plurality of retaining portions 31 (shown in FIG. 5), a plurality of second retaining portions 24, and a first projecting portion 32 (shown in FIG. 5). The body portion 23 includes the bottom wall 33, and the peripheral wall 34 formed on and projected perpendicularly from an outer peripheral edge of the bottom wall 33. The body portion 23 has a channel-shaped (U-shaped) cross-section. The bottom wall 33 has a rectangular shape when viewed from the top, and is generally equal in plane shape to the shallow groove portion 14. The bottom wall 33 positions the wire harness 3 on its surface.

The peripheral wall 34 includes three members. Therefore, the peripheral wall 34 is formed on and project perpendicularly from three of the four outer edges of the bottom wall 33, respectively. The members of peripheral wall 34 are extended from the bottom wall 33 in the same direction. The body portion 23 of the above construction positions the wire harness 3, passing through the tube 19, in a space formed by the bottom wall 33 and the peripheral wall 34. Therefore, the inner grommet 17 positions the wire harness 3 on the bottom wall 33.

The harness guide portion 30 includes a plurality of walls 35 formed on and projecting perpendicularly from the bottom wall 33 of the body portion 23 in a direction away from the peripheral wall 34. These walls 35 project perpendicularly from that outer edge of the bottom wall 33 from which any peripheral wall 34 does not project perpendicularly. The harness guide portion 30 positions the wire harness 3, passing through the space between the grommet body 16 and the body portion 23 of the inner grommet 17, on the walls 35 to guide this wire harness 3 to the inner surface of the door panel 8 as will be described later.

Each of the plurality of retaining portions 31 is in the form of a projection of a convex shape projecting from the outer surface of the peripheral wall 34. The plurality of retaining portions 31 are spaced from one another. Each retaining portion 31 is inserted into the hole 28 in the corresponding receiving portion 27 to be retainingly engaged with the receiving portion 27.

The second retaining portions 24 project from a surface of the bottom wall 33 in the direction away from the peripheral walls 34 toward the recess 9. The second retaining portions 24 are retainingly engaged respectively in the holes 15 formed through the bottom of the deep groove portion 13 of the recess 9.

The first projecting portion 32 of a convex shape is formed on that edge 34a of the peripheral wall 34 remote from the bottom wall 33. The first projecting portion 32 has a semi-circular cross-section. As shown in FIG. 5, the first projecting portion 32 is formed on the edge 34a of the peripheral wall 34 over the entire length of the edge 34a. When the grommet body 16 and the inner grommet 17 are fixed to each other with the retaining portions 31 retainingly engaged with the respective receiving portions 27, the first projecting portion 32 abuts against the abutment portion 29, and bites into this abutment portion 29.

The inner grommet 17 is located relative to the grommet body 16, with the edge 34a of the peripheral wall 34 facing to the abutment portion 29 (that is, facing to the flat portion 18 of the grommet body 16), and then is moved toward the grommet body 16. Then, when the retaining portions 31 are brought into retaining engagement with the respective receiving portions 27, the inner grommet 17 is attached to the grommet body 16. In this manner, the inner grommet 17 and the grommet body 16 are fixed to each other. When the inner grommet 17 and the grommet body 16 are thus fixed to each other, the first projecting portion 32 abuts against the abutment portion 29, and bites thereinto. As a result, a watertight seal is formed between the first projecting portion 32 and the abutment portion 29, so that a watertight seal is formed between the grommet body 16 and the inner grommet 17. The body portion 23 of the inner grommet 17 is attached to the grommet body 16 as described above, and the second retaining portions 24 are retainingly engaged respectively in the holes 15. Thus, the inner grommet 17 is attached to both of the flat portion 18 of the grommet body 16 and the deep groove portion 13 of the recess 9.

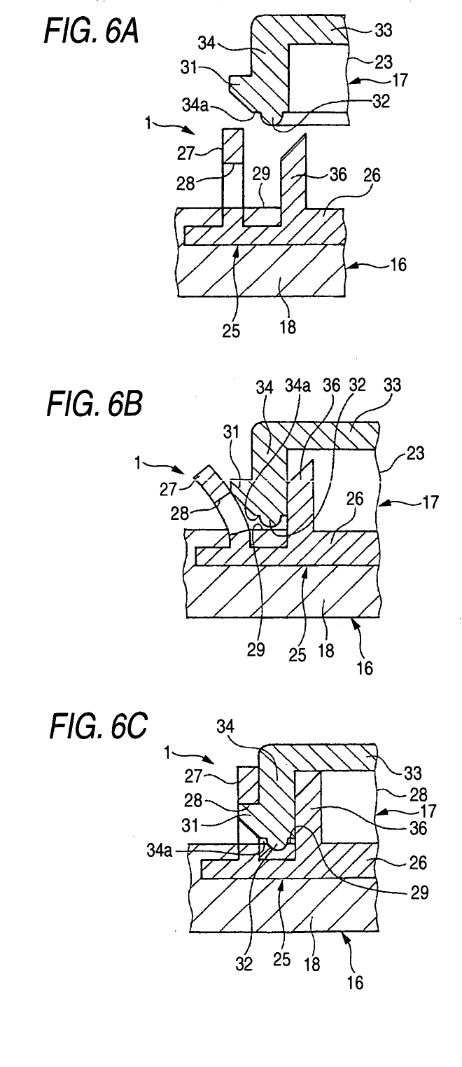

The grommet 1 of the above construction is assembled in the following manner. The wire harness 3 is passed through the tube 19 along the body portion 26 in FIG. 2, and is positioned on the flat portion 18 of the grommet body 16. Then, the inner grommet 17 and the grommet body 16 are located relative to each other with the edge 34a of the peripheral wall 34 facing to the flat portion 18 as shown in FIG. 6A. Then, the inner grommet 17 and the grommet body 16 are moved closer to each other, thereby brining the first projecting portion 32 into abutting engagement with the abutment portion 29 as shown in FIG. 6B. Then, the inner grommet 17 and the grommet body 16 are further moved closer to each other, thereby retainingly engaging the retaining portions 31 with the respective receiving portions 27. As a result, the first projecting portion 32 bites into the abutment portion 29 to form a watertight seal therebetween as shown in FIG. 6C. In this manner, the wire harness 3 is passed through the space between the grommet body 16 and the inner grommet 17.

Then, the wire harness 3 is extended along the walls 35 of the harness guide portion 30 along the body portion 26 in FIG. 2, and the wire harness 3 is fixed to the walls 35, for example, by winding a tape around the wire harness 3 and the walls 35. Thus, the grommet 1 is assembled, and is mounted on the wire harness 3.

Then, the second retaining portions 24 are retainingly engaged respectively in the holes 15 formed in the door panel 8, thereby attaching the grommet 1 to the door panel 8. As a result, each of the second projecting portions 20 and 21 abuts against the door panel 8 to form a watertight seal therebetween. Then, the connectors 5a and 5b of the wire harness 3 are connected to the mating connectors, respectively, and the wire harness 3 is installed on the car body and the door 2. The wire harness 3 electrically connects the car body-side wire harness to the various electronic equipments on the door 2.

Thus, in the grommet 1, the first projecting portion 32 abuts against the abutment portion 29 to form a watertight seal therebetween, and each of the second projecting portions 20 and 21 abuts against the door panel 8 to form a watertight seal therebetween. Therefore, liquid such as external water is prevented from depositing on the wire harness 3 passing through the space between the grommet body 16 and the inner grommet 17.

In this embodiment, the abutment portion 29, facing to the edge 34a of the peripheral wall 34 of the inner grommet 17, is provided at the flat portion 18 of the grommet body 16, and the first projecting portion 32 is formed on the edge 34a of the peripheral wall 34. The grommet body 16 is made of the elastic material, and the inner grommet 17 is made of the synthetic resin. Therefore, when the grommet body 16 and the inner grommet 17 are fixed to each other, the first projecting portion 32 bites into the abutment portion 29. Therefore, the grommet body 16 made of the elastic material is held in direct contact with the inner grommet 17 made of the synthetic resin, and a watertight seal is positively formed between the grommet body 16 and the inner grommet 17 by the first projecting portion 32 and the abutment portion 29. Therefore, the grommet 1 prevents liquid such as water from depositing on the wire harness 3 received therein.

The abutment portion 29 faces to the edge 34a of the peripheral wall 34 over the entire length of the edge 34a. Therefore, the first projecting portion 32 and the abutment portion 29 are held in contact with each other over the entire length of the peripheral wall 34, and the grommet body 16 made of the elastic material is held in direct contact with the inner grommet 17 made of the synthetic resin. Therefore, in the grommet 1, a watertight seal is positively formed between the grommet body 16 and the inner grommet 17 over the entire length of the peripheral walls 34, thereby positively preventing liquid such as water from depositing on the wire harness 3 received in the grommet 1.

The first projecting portion 32 is formed on the edge 34a of the peripheral wall 34, and therefore when the grommet body 16 and the inner grommet 17 are fixed to each other, the first projecting portion 32 bites into the abutment portion 29. Therefore, the grommet body 16 made of the elastic material is held in direct contact with the inner grommet 17 made of the synthetic resin. Therefore, a watertight seal is more positively formed between the grommet body 16 and the inner grommet 17, and the grommet 1 more positively prevents liquid such as water from depositing on the wire harness 3 received therein.

By retainingly engaging the receiving portions 27 with the respective retaining portions 31, the grommet body 16 and the inner grommet 17 can be positively and easily fixed to each other. Therefore, the grommet 1 can be easily assembled.

The inner grommet 17 has the second retaining portions 24 for retaining engagement with the door panel 8. Therefore, the inner grommet 17 and hence the grommet 1 can be easily fixed to the door panel 8.

The grommet body 16 has the second projecting portions 20 and 21. Therefore, liquid such as water is prevented from intruding between the grommet body 16 and the door panel 8. Therefore, the grommet 1 still more positively prevents liquid such as water from depositing on the wire harness 3 received therein.

In the above embodiment, the grommet 1 is mounted on the door panel 8. However, the grommet 1 of the invention can be mounted on other car body-forming panel than the door panel 8. The constructions of the retaining portions 31, receiving portions 27 and second retaining portions 24 are not limited to the above embodiment, and they can have any other suitable construction.

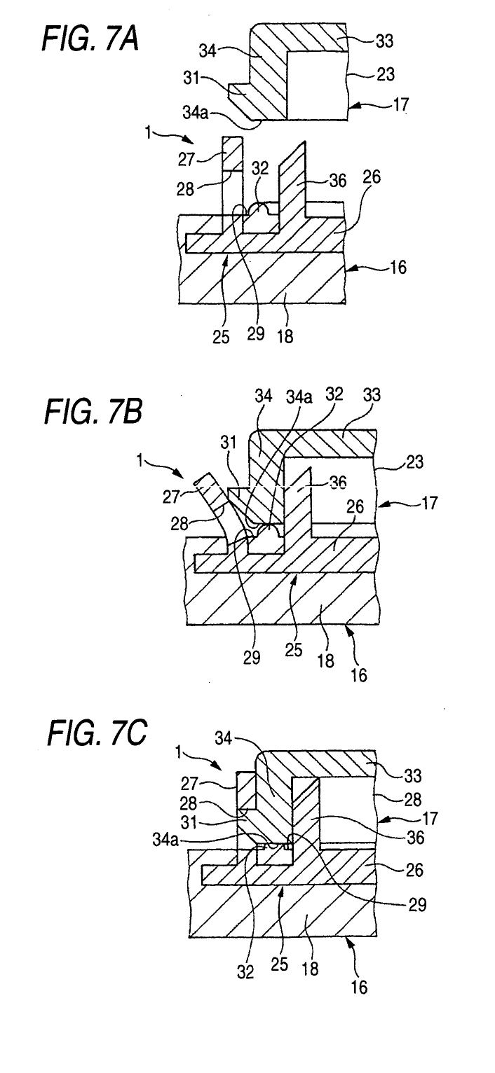

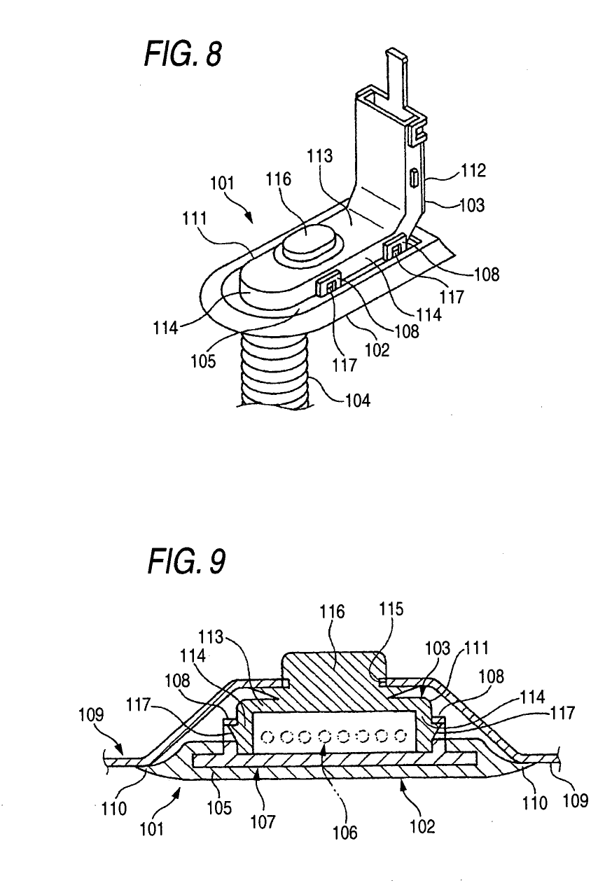

In the above embodiment, the lip 32 is formed on the edge 34a of the peripheral wall 34. In the invention, however, a first projecting portion 32 can be formed on the abutment portion 29 of the grommet body 16 as shown in FIGS. 7A to 7C. In this case, the first projecting portion 32 is formed integrally with the abutment portion 29 and hence integrally with the grommet body 16, and preferably the first projecting portion 32 is molded of the elastic material forming the grommet body 16.

In this case, also, for fixing the grommet body 16 and the inner grommet 17 to each other, the inner grommet 17 and the grommet body 16 are so located relative to each other that the edge 34a of the peripheral wall 34 faces to the flat portion 18 as shown in FIG. 7A. Then, the inner grommet 17 and the grommet body 16 are moved closer to each other, thereby brining the first projecting portion 32 on the abutment-portion 29 into abutting engagement with the edge 34a of the peripheral wall 34 as shown in FIG. 7B.

Then, the inner grommet 17 and the grommet body 16 are further moved closer to each other, thereby retainingly engaging the retaining portions 31 with the respective receiving portions 27. As a result, the first projecting portion 32 is squeezed by the edge 34a of the peripheral edge 34 to form a watertight seal therebetween as shown in FIG. 7C. Thus, the grommet body 16 and the inner grommet 17 are fixed to each other, and a watertight seal is formed between the first projecting portion 32 and the edge 34a of the peripheral wall 34, so that a watertight seal is formed between the grommet body 16 and the inner grommet 17.

In this case, also, the abutment portion 29 to which the edge 34a of the peripheral wall 34 of the inner grommet 17 faces is formed at the flat portion 18 of the grommet body 16. The grommet body 16 is made of the elastic material, and the inner grommet 17 is made of the synthetic resin. Therefore, when the grommet body 16 and the inner grommet 17 are fixed to each other, the first projecting portion 32 is squeezed by the edge 34a of the peripheral wall 34a. Therefore, the grommet body 16 made of the elastic material is held in direct contact with the inner grommet 17 made of the synthetic resin, and a watertight seal is positively formed between the grommet body 16 and the inner grommet 17 by the first projecting portion 32 and the edge 34a of the peripheral wall 34. Therefore, the grommet 1 prevents liquid such as water from depositing on the wire harness 3 received therein.

The above embodiment is directed merely to a representative form of the invention, and the invention is not limited to the above embodiment. Namely, various modifications can be made without departing from the subject matter of the invention.

1. A grommet comprising:
a grommet body that is made of an elastic material and includes a flat portion which has a through hole and a tube portion which is communicated with the through hole; and
an inner grommet that is made of a synthesis resin and includes a bottom wall and a periphery wall which is extended from an outer edge of the bottom wall in a direction facing to the grommet body,
wherein the flat portion, the bottom wall and the periphery wall define a portion through which a wire is adapted to be passed,
wherein a first projecting portion is formed at one of an edge of the periphery wall which is opposed to the bottom portion and an abutment portion which is disposed at the flat portion and faces to the edge of the periphery wall, and
wherein when the inner grommet is fixed to the grommet body, the first projecting portion is held in contact with the other of the edge of the periphery wall and the abutment portion.

2. The grommet according to claim 1, wherein an entire length of the edge of the periphery wall faces to the abutment portion.

3. The grommet according to claim 1, wherein the first projecting portion is formed at the edge of the periphery wall.

4. The grommet according to claim 1, wherein the first projecting portion is formed at the abutment portion.

5. The grommet according to claim 1,
wherein a plurality of receiving portions are provided at the flat portion,
wherein a plurality of retaining portions are provided at outsides of the periphery wall and are corresponding to the receiving portions, and
wherein the retaining portions are engaged to the receiving portions, so that the inner grommet is fixed to the grommet body.

6. The grommet according to claim 1,
wherein a plurality of retaining portions are formed at a surface of the bottom wall opposed to the periphery wall, and
wherein the retaining portions are retained to a panel member that is a part of automobile parts.

7. The grommet according to claim 6,
wherein second projecting portions are formed at portions of an edge of the grommet body, and
wherein the second projecting portions are held in contact with portions of the panel member when the retaining portions are retained to the panel member.
